(19) United States
(12) Patent Application Publication
(10) Pub. No.: US 2026/0365043 A1
(43) Pub. Date: Nov. 19, 2026

(54) POWER SUPPLY SYSTEM FOR VEHICLE

(71) Applicant: TOYOTA JIDOSHA KABUSHIKI KAISHA, Toyota-shi (JP)

(72) Inventor: Shinichi INOUE, Okazaki-shi (JP)

(73) Assignee: TOYOTA JIDOSHA KABUSHIKI KAISHA, Toyota-shi (JP)

(21) Appl. No.: 19/210,177

(22) Filed: May 16, 2025

(30) Foreign Application Priority Data
Oct. 1, 2024 (JP) 2024-172540

(51) Int. Cl. B60L 50/61; B60R 16/033

(52) U.S. Cl. CPC B60L 50/61; B60R 16/033; B60L 2210/10

(57) ABSTRACT

A power supply system mounted on a vehicle, comprising: a DC-to-DC converter supplying electric power of a battery to an accessory load; an alternator connected in parallel with a DC-to-DC converter that is capable of supplying electric power generated by driving the engine to the accessory load; and a control device controlling the accessory load based on the states of DC-to-DC converter and the alternator, wherein when the electric power consumption of the accessory load exceeds a maximum value of the rated output power of DC-to-DC converter, the control device limits the operation of the accessory load if the engine speed is less than a first threshold value, the alternator is not operating even if the engine speed is equal to or greater than a first threshold value, or the rate of operating is equal to or greater than a second threshold value even if the alternator is operating.

### CROSS-REFERENCE TO RELATED APPLICATION

This application claims priority to Japanese Patent Application No. 2024-172540 filed on Oct. 1, 2024. The disclosure of the above-identified application, including the specification, drawings, and claims, is incorporated by reference herein in its entirety.

### BACKGROUND

### 1. Technical Field

The present disclosure relates to a power supply system that is installed in a vehicle.

### 2. Description of Related Art

Japanese U.S. Pat. No. 6,308,225 (JP 6308225 B) discloses a power supply system for a vehicle that supplies electric power to an accessory load using an alternator and a direct current (DC)-to-DC converter as power sources. The power supply system is described as limiting operation of the accessory load in an event of an abnormality in the alternator.

### SUMMARY

In the power supply system described in JP 6308225 B, no assumption is made regarding when an abnormality occurs in the DC-to-DC converter, and accordingly there is a problem in that operation of the accessory load cannot be appropriately limited when an abnormality occurs in the DC-to-DC converter.

The present disclosure has been made in view of the above problems, and an object thereof is to provide a power supply system for a vehicle that can appropriately limit operation of an accessory load even when an abnormality occurs in either of an alternator and a DC-to-DC converter.

In order to solve the above problems, an aspect of the present disclosure is a power supply system that is installed in a vehicle, the power supply system including a DC-to-DC converter that supplies electric power of a battery to an accessory load,
an alternator that is connected in parallel with the DC-to-DC converter such that electric power that is generated by driving of an engine is suppliable to the accessory load, and
a control device that controls the accessory load based on a state of the DC-to-DC converter and the alternator, in which
when electric power consumption of the accessory load exceeds a maximum value of rated output electric power of the DC-to-DC converter, the control device limits operation of the accessory load when revolutions of the engine are lower than a first threshold value, or the revolutions of the engine are no lower than the first threshold value but the alternator is not operating, or the alternator is operating but a rate of operating is no lower than a second threshold value.

According to the vehicle power supply system of the present disclosure, the states of both the alternator and the DC-to-DC converter are determined, and accordingly even when an abnormality occurs in either the alternator or the DC-to-DC converter, operation of the accessory load can be limited as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram of a vehicle power supply system according to an embodiment of the present disclosure; and

FIG. 2 is a process flowchart of accessory load operation control executed by the vehicle power supply system.

### DETAILED DESCRIPTION OF EMBODIMENTS

The vehicle power supply system of the present disclosure monitors the rotational speed of the engine (driving state), the rate of operating of the alternator, and the power state of DC-to-DC converters, and appropriately limits the operation required for the accessory loads based on the monitoring.

Hereinafter, an embodiment of the present disclosure will be described in detail with reference to the drawings.

### Embodiments

### Configuration

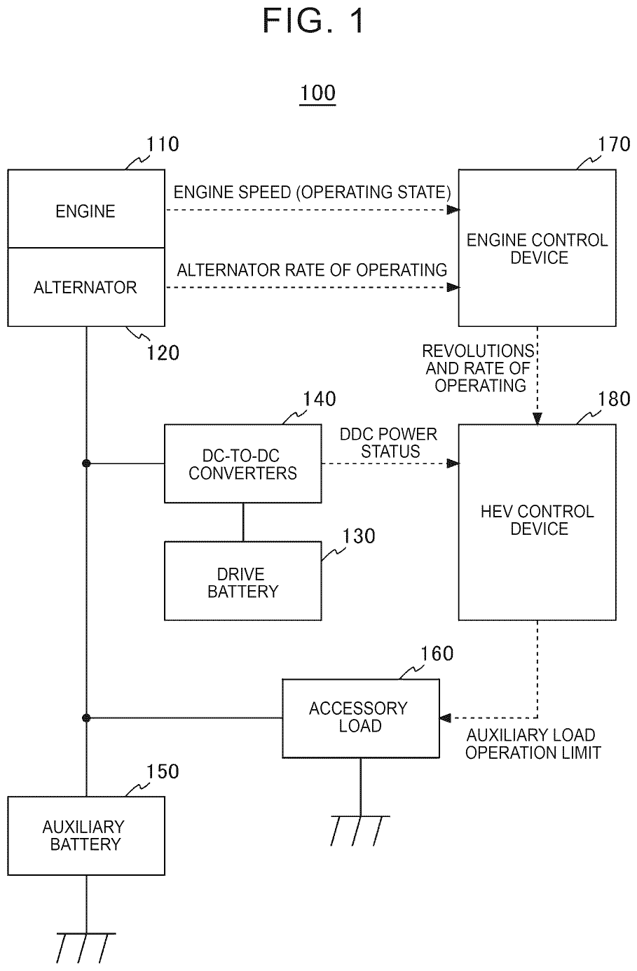

FIG. 1 is a functional block diagram illustrating a schematic configuration of a vehicle power supply system 100 and a peripheral portion thereof according to an embodiment of the present disclosure. The functional blocks illustrated in FIG. 1 include an engine 110, an alternator 120, a driving battery 130, and DC-to-DC converters 140. The functional blocks illustrated in FIG. 1 include an auxiliary battery 150, an accessory load 160, an engine control device 170, and a HEV control device 180. In FIG. 1, the wiring in which electric power is exchanged is indicated by a solid line, and the wiring in which information, instructions, and the like are exchanged is indicated by a dotted line.

The vehicle power supply system 100 may be mounted on a vehicle such as a hybrid electric vehicle (HEV) or a plug-in hybrid electric vehicle (PHEV), for example. These vehicles are vehicles that use an engine 110 that is an internal combustion engine and an electric motor (not shown) as a power source.

The engine 110 is an internal combustion engine that generates rotation necessary for the alternator 120 to generate power. The power of the engine 110 may be used to drive the vehicle, or may be used to charge the driving battery 130 or the auxiliary battery 150 via the alternator 120. Driving of the engine 110 is controlled by the engine control device 170. The engine speed [rpm] indicating the operating status of the engine 110 is outputted (transmitted) from the engine 110 to the engine control device 170. The information can be detected by a predetermined sensor provided in the engine 110.

The alternator 120 is a generator capable of generating electric power in response to rotation of the engine 110. The alternator 120 is connected in parallel with DC-to-DC converter 140 so that the electric power generated by the alternator 140 and the electric power generated by the alternator can be supplied to the auxiliary battery 150 and the accessory load 160. Whether or not the alternator 120 can output the generated electric power is controlled by the engine control device 170. Further, the information of the rate of operating [%] indicating the current power generation state with respect to the maximum power generation capacity of the alternator 120 is output (transmitted) from the alternator 120 to the engine control device 170. The information can be detected by a predetermined sensor provided in the alternator 120.

The driving battery 130 is a secondary battery configured to be chargeable and dischargeable, such as a lithium-ion battery. The driving battery 130 is capable of outputting the electric power stored therein to DC-to-DC converters 140. The driving battery 130 is capable of charging electric power generated by the alternator 120 and electric power stored in the auxiliary battery 150 via DC-to-DC converters 140.

DC-to-DC converter 140 is a generator that is provided between the driving battery 130 and the accessory load 160 and is capable of converting the electric power of the driving battery 130, which is a power source, into electric power of a voltage suitable for the accessory load 160 and outputting the electric power to the accessory load 160. The operation of DC-to-DC converters 140 is controlled by HEV control device 180. The [V,A] relating to the output status of DC-to-DC converter (DDC) 140 is output (transmitted) to HEV control device 180. DC-to-DC converters 140 may be configured to detect a predetermined amount of time.

The auxiliary battery 150 is a secondary battery configured to be chargeable and dischargeable, such as a lithium-ion battery or a lead-acid battery. The auxiliary battery 150 can output the electric power stored therein to the accessory load 160. The auxiliary battery 150 is a battery having a rated voltage lower than that of the driving battery 130.

The accessory load 160 is one or more auxiliary electronic devices, equipment, or the like that consume electric power mounted on the vehicle. The accessory loads 160 are configured to operate, in principle, by the electric power of the driving battery 130 supplied via DC-to-DC converters 140 and the electric power generated by the alternator 120. Further, the accessory load 160 is configured to be able to operate using the electric power of the auxiliary battery 150 in a specific scene. In addition, the operation of the accessory loads 160 is appropriately limited in accordance with instructions of HEV control device 180 based on the respective conditions of the engine 110, the alternator 120, and DC-to-DC converters 140.

The engine control device 170 acquires information on the driving state (engine speed, alternator rate of operating) from the engine 110 and the alternator 120, respectively, and controls the operation of the engine 110 and the alternator 120 based on the information. The information and the like acquired from the engine 110 and the alternator 120 are outputted (transmitted) to HEV control device 180.

HEV control device 180 acquires information on the driving state (DDC outputting state) from DC-to-DC converters 140 and information on the engine speed and the alternator rate of operating from the engine control device 170. HEV control device 180 controls the operation of DC-to-DC converters 140 based on these data. Further, HEV control device 180 limits the operation of the accessory loads 160 based on the above-described data. As an example of the limitation of the operation, a part of the functions of the accessory load 160 may be stopped, or an upper limit value or a lower limit value may be provided in the operation range.

Some or all of the above-described engine-control device 170 and HEV control device 180 may be configured by one or more electronic control units (ECU) including a processor, memories, input/output interfaces, and the like. The electronic control unit is typically a microcomputer or the like. The electronic control unit can realize some or all of the functions performed by the above-described engine control device 170 and HEV control device 180 by the processor reading and executing a program stored in the memory.

### Control

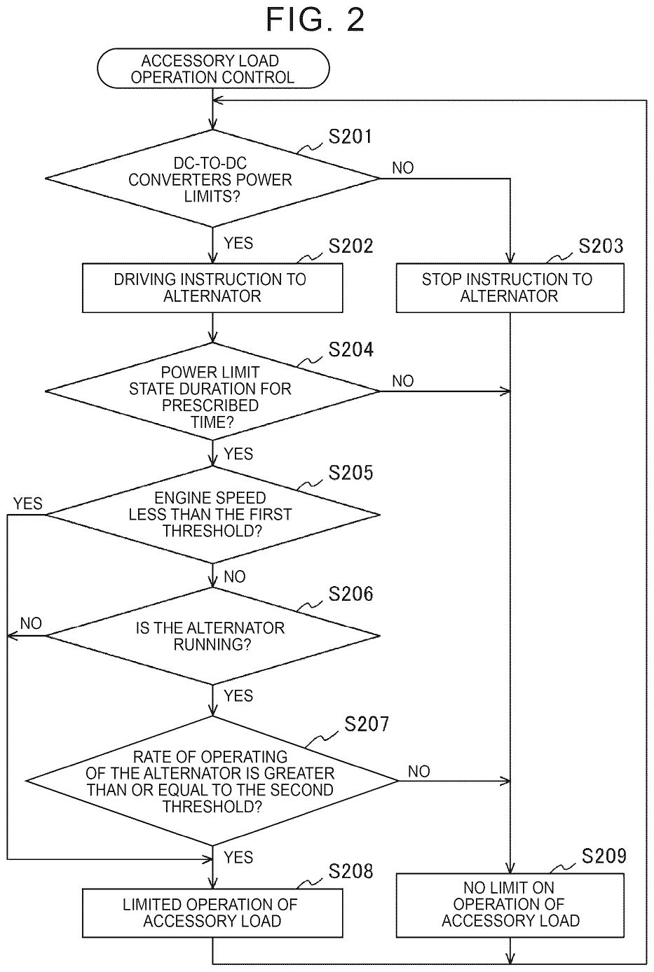

Next, with further reference to FIG. 2, control performed by the vehicle power supply system 100 according to an embodiment of the present disclosure will be described. FIG. 2 is a flow chart for explaining a process sequence of accessory load operation control executed by the engine control device 170 and HEV control device 180 of the vehicle power supply system 100.

The accessory load operation control illustrated in FIG. 2 is repeatedly executed until the vehicle power supply system 100 is started (Ready-ON) and the vehicle power supply system 100 is stopped (Ready-OFF).

### S201

HEV control device 180 determines whether or not DC-to-DC converters 140 have reached the power generation limits. More specifically, HEV control device 180 determines whether the electric power consumed by the accessory loads 160 exceeds a predetermined maximum of the rated output of DC-to-DC converters 140. That is, when the power consumed by the accessory load 160 exceeds the maximum rated output electric power of DC-to-DC converter 140, it is determined that DC-to-DC converter 140 has reached the power generation limit. This determination can be determined based on DDC output-state (voltage/current) acquired from DC-to-DC converters 140.

If it is determined that DC-to-DC converters 140 have reached the power generation limit (S201, Yes), the process proceeds to S202. On the other hand, if it is determined that DC-to-DC converters 140 have not reached the power generation limit (S201, No), the process proceeds to S203.

### S202

Since DC-to-DC converters 140 have reached the power generation limits, the engine control device 170 instructs the alternator 120 to drive in order to satisfy the electric power demand of the accessory loads 160. When the alternator 120 is already being driven, a continuous driving is instructed. When a driving instruction is given to the alternator 120, the process proceeds to S204.

### S203

The engine control device 170 instructs the alternator 120 to stop driving because DC-to-DC converter 140 has not reached the power generation limit and the electric power demand of the accessory load 160 can be covered only by DC-to-DC converter 140. When the alternator 120 is already stopped, a continuous stop is instructed. When a stopping instruction is given to the alternator 120, the process proceeds to S209.

### S204

When DC-to-DC converters 140 have reached the power generation limit, HEV control device 180 determines whether or not the power generation limit is reached for a predetermined period of time. This determination takes into account the delay time (time lag) from when the engine control device 170 issues a drive instruction to the alternator 120 in the above S202 until when the alternator 120 actually starts moving. Therefore, the predetermined time is set to an arbitrary value that is equal to or larger than the time lag.

When it is determined that the power generation limit status of DC-to-DC converters 140 continues for a predetermined period (S204, Yes), the process proceeds to S205. On the other hand, if it is determined that the power generation limit status of DC-to-DC converters 140 does not continue for a predetermined period (S204, No), the process proceeds to S209.

### S205

The engine control device 170 determines whether or not the rotational speed of the engine 110 is less than the first threshold value. This determination is made to see if the engine 110 is running after waiting for a time lag. The first threshold value is set to a predetermined value at which the driving of the engine 110 can be confirmed, based on the structure, performance, and the like of the engine 110.

When it is determined that the rotational speed of the engine 110 is less than the first threshold value (S205, Yes), it is determined that the alternator 120 is not driven based on the drive instruction, and the process proceeds to S208. On the other hand, when it is determined that the rotational speed of the engine 110 is equal to or higher than the first threshold value (S205, no), it is determined that the alternator 120 is driven based on the drive instruction, and the process proceeds to S206.

### S206

The engine control device 170 determines whether or not the alternator 120 is operating in response to the engine 110 being driven. This determination is made to ascertain whether the engine 110 is rotating normally by the number of revolutions that the alternator 120 can generate. Whether or not the alternator 120 is operating can be determined based on whether or not the rate of operating of the alternator 120 is zero.

When it is determined that the alternator 120 is in operation (S206, Yes), it is determined that there is no abnormality in the alternator 120, and the process proceeds to S207. On the other hand, when it is determined that the alternator 120 is not in operation (S206, no), it is determined that the alternator 120 is abnormal or that the engine 110 is not driven at a rotational speed higher than or equal to the rotational speed at which the alternator 120 can generate electric power. Then, the process proceeds to S208.

### S207

The engine control device 170 determines whether or not the rate of operating of the alternator 120 is equal to or greater than a second threshold value. This determination is made to determine whether the alternator 120 is operating near the power generation limit. Therefore, the second threshold value is arbitrarily set based on a rate of operating in which the alternator 120 is in a power generation limit state.

When it is determined that the rate of operating of the alternator 120 is equal to or higher than the second threshold value (S207, Yes), it is determined that the alternator 120 is operating in a condition close to the power generation limit, and the process proceeds to S208. On the other hand, when it is determined that the rate of operating of the alternator 120 is less than the second threshold value (S207, No), it is determined that there is still a margin up to the power generation limit of the alternator 120, and the process proceeds to S209.

### S208

HEV control device 180 instructs the accessory loads 160 to limit operation. This limiting indication reduces the electric power consumed by the accessory load 160. The electric power consumed by the accessory load 160 after the reduction may be electric power equal to or less than the power generation limit of DC-to-DC converter 140 alone, or may be electric power equal to or less than the power generation limit of the combined DC-to-DC converter 140 and the alternator 120. In the former case, only DC-to-DC converter 140 operates, and in the latter case, both DC-to-DC converter 140 and the alternator 120 operate. When an instruction to limit the operation is given to the accessory loads 160 (there is an operation limit), the process returns to S201.

### S209

HEV control device 180 does not instruct the accessory loads 160 to limit operation. Therefore, in this case, electric power is consumed according to the demand of the accessory load 160. If there is no limit on the operation of the accessory loads 160, the process returns to S201.

### Action and Effect

As described above, according to the vehicle power supply system 100 according to the embodiment of the present disclosure, in the power supply configuration in which DC-to-DC converters 140 and the alternator 120 are connected in parallel as the electric power supply source to the accessory load 160, the operation of the accessory load 160 is limited under a predetermined condition. The predetermined condition is a condition that the rotational speed of the engine 110 is less than the first threshold when the electric power consumed by the accessory load 160 exceeds the maximum of the rated output power of DC-to-DC converter 140. Further, the predetermined condition is a condition that, when the electric power consumed by the accessory load 160 exceeds the maximum of the rated output electric power of DC-to-DC converter 140, the alternator 120 is not in operation even if the rotational speed of the engine 110 is equal to or higher than the first threshold. Further, the predetermined condition is a condition in which, when the electric power consumed by the accessory load 160 exceeds the maximum value of the rated output electric power of DC-to-DC converter 140, the rotational speed of the engine 110 is equal to or greater than the first threshold value and the rate of operating thereof is equal to or greater than the second threshold value even when the alternator 120 is in operation.

Due to the operation limitation of the accessory load 160, the operation limitation of the accessory load 160 can be appropriately performed even when an abnormality occurs in either the alternator 120 or DC-to-DC converter 140.

An embodiment of the present disclosure has been described above. The present disclosure can be viewed as a method executed by a vehicle power supply system including not only a vehicle power supply system but also a processor, a memory, and the like, a program for executing the method, and the like. Further, the present disclosure can be regarded as a computer-readable non-transitory storage medium storing a program, a vehicle equipped with a vehicle power supply system, or the like.

The vehicle power supply system of the present disclosure can be used for a vehicle equipped with a power supply system including a DC-to-DC converter and an alternator.

1. A power supply system that is installed in a vehicle, the power supply system comprising:
a direct current (DC)-to-DC converter configured to supply electric power of a battery to an accessory load;
an alternator that is connected in parallel with the DC-to-DC converter such that electric power that is generated by driving of an engine is supplied to the accessory load; and
a processor configured to control the accessory load based on a state of the DC-to-DC converter and the alternator, wherein
the processor is further configured to limit operation of the accessory load in a case where electric power consumption of the accessory load exceeds a maximum value of rated output electric power of the DC-to-DC converter, an engine speed is equal to or greater than a first threshold value, and the alternator is not operating, and
the first threshold value is an engine speed at or above which the alternator generates electric power.

2-3. (canceled)

4. The power supply system according to claim 1, wherein the processor is further configured to limit the operation of the accessory load in a case where the electric power consumption of the accessory load exceeds the maximum value of the rated output electric power of the DC-to-DC converter and the engine speed is lower than the first threshold value.

5. The power supply system according to claim 1, wherein
the processor is further configured to limit the operation of the accessory load in a case where the electric power consumption of the accessory load exceeds the maximum value of the rated output electric power of the DC-to-DC converter, the alternator is operating, and an operating rate of the alternator is equal to or greater than a second threshold value, and
the second threshold value is an operating rate at or above which the alternator operates at a power generation limit.
